(19) United States
(12) Patent Application Publication
(10) Pub. No.: US 2008/0104181 A1
(43) Pub. Date: May 1, 2008

(54) ELECTRONIC MAIL PROCESSING SYSTEM

(76) Inventor: Tal Golan, Irvine, CA (US)

Correspondence Address: KAUTH , POMEROY , PECK & BAILEY ,LLP, P.O. BOX 19152, IRVINE, CA, 92623, US

(21) Appl. No.: 11/745,950

(22) Filed: May 8, 2007

Related U.S. Application Data
(60) Provisional application No. 60/855,040, filed on Oct. 26, 2006.

(51) Int. Cl. G06F 15/16

(52) U.S. Cl. 709/206

(57) ABSTRACT

Systems and methods for processing electronic messages are described. One embodiment of the invention includes a message processing system connected to a network and the message processing system includes a mail processing unit connected to the network and a mail server connected to the mail processing unit. In addition, the mail processing unit is configured to apply a challenge response process to messages addressed to the at least one user and the mail server is configured to transfer electronic messages from one user to another user. In other embodiments, processes for reformatting, storing, forwarding, and encrypting electronic messages are performed.

### CROSS-REFERENCE TO RELATED APPLICATION(S)

The present application claims priority to of U.S. Provisional Application Ser. No. 60/855,040 entitled “Electronic Mail Processing System” the entirety of which is incorporated herein by reference.

### BACKGROUND

The present invention relates generally to message processing systems and more specifically to message processing systems that process messages as they pass between a mail server and a network.

Unsolicited messages can pose a significant problem for users of message services such as email. A number of systems attempt to filter undesired messages using complex filtering algorithms that inspect the content of the message. Other systems attempt to filter messages using more straightforward approaches such as requesting that unknown senders provide an acknowledgement prior to the message being forwarded. Such systems are commonly known as challenge response systems. A challenge response system typically maintains a white list of authorized recipients and often contains a black list of recipients that are not authorized to send mail. When a message is received from someone who is neither on the white list or the black list, then a challenge message is sent out that requires a response within a predetermined period of time for the message to be released to the intended recipient. If a response is received, the message is released to the recipient and the sender is added to the recipient's white list.

### SUMMARY OF THE INVENTION

Systems and methods for processing electronic messages are described. In one aspect of the invention, a device interposed between one mail server and another mail server or a software application resident on one of the mail servers processes messages passing between the mail servers. One embodiment of the invention includes a message processing system connected to a network and the message processing system includes a mail processing unit connected to the network and a mail server connected to the mail processing unit. In addition, the mail processing unit is configured to apply a challenge response process to messages addressed to the at least one user and the mail server is configured to transfer electronic messages from one user to another user.

In a further embodiment, the mail processing unit is connected to the network via a firewall.

In another embodiment the mail processing unit and mail server are implemented on a single server using software.

A still further embodiment includes a microprocessor connected to memory, a storage device and an I/O interface. In addition, the I/O interface includes a network connection configured to communicate with a network, the I/O interface includes a mail server connection configured to communicate with a mail server, the microprocessor is configured to receive electronic message from the network connection, the microprocessor is configured to apply a challenge response process to the received electronic messages and the microprocessor is configured to forward filtered electronic messages via the mail server connection.

In still another embodiment, the memory includes a black list of senders and a white list of senders, the microprocessor is configured to forward all received electronic messages via the mail server connection that include a sender address that is on the white list of senders and the microprocessor is configured to delete all received electronic messages that include a sender address that is on the black list of senders.

In yet another embodiment, the memory includes a challenge list of addresses to which challenge messages have been sent, the microprocessor is configured to store on the storage device all received electronic messages that include a sender address that is not on the white list, or the black list, the microprocessor is configured to send a challenge message in response to all received electronic messages that include a sender address that is not on the white list, the black list nor the challenge list, and the microprocessor is configured to add the address of the sender to which a challenge message has been sent to the challenge list.

In a yet further embodiment, the microprocessor is configured to remove from the challenge list the address of a sender of a response to a challenge message and to place the address on the white list, the microprocessor is configured to locate messages stored on the storage device with a sender address that matches the sender address of the response to the challenge message, and the microprocessor is configured to forward the located messages via the mail server connection.

In another embodiment again, the microprocessor is configured to parse filtered electronic messages that are formatted in accordance with the Simple Mail Transfer Protocol to extract information into fields, the microprocessor is configured to generate new electronic messages using the information extracted into the fields, the microprocessor is configured to store the new electronic messages on the storage device, and the microprocessor is configured to forward the new electronic messages via the mail server connection.

In a further embodiment again, the electronic messages are stored on the storage device within a database.

In still yet another embodiment, the microprocessor is configured to retrieve electronic messages stored on the storage device by searching fields of information within the electronic messages.

In a still yet further embodiment, the microprocessor is configured to store attachments to the electronic messages on the storage device, and the microprocessor is configured to replace the attachments to the electronic messages with links to the stored attachments.

In still another embodiment again, the microprocessor is configured to screen attachments to detect attachments with characteristics that indicate that access to the attachment should be restricted.

In a still further embodiment again, the microprocessor is configured to buffer a message received from the mail server connection.

In yet another embodiment again, the buffered message is addressed to a destination mail server, and the microprocessor is configured to forward the buffered message to the destination mail server after a predetermined time period.

In a yet further embodiment again, the buffered message is addressed to a destination mail server, and the microprocessor is configured to forward the buffered message upon receipt of confirmation that the destination mail server accepts responsibility for the delivery of the message.

In another further embodiment, the microprocessor is configured to release the buffered message upon receipt of authorization from the sender of the message.

In still another further embodiment, the buffered message is addressed to a first destination server; and the microprocessor is configured to address the buffered message to a second destination server in response to an instruction from the sender of the message.

In yet another further embodiment, the buffered message is addressed to a destination mail server, the microprocessor is configured to determine that the destination mail server is connected to a second mail processing unit, and the microprocessor is configured to encrypt at least a portion of the buffered message and forward the buffered message to the second mail processing unit.

In another further embodiment again, a server configured to connect to a remote message server via a network and the server is configured to control the remote messaging server to apply a challenge response process to messages quarantined on the remote messaging server.

In still another further embodiment again, the server maintains a white list of allowed addresses, the server maintains a black list of forbidden addresses, the server and the remote messaging server are configured to release all quarantined messages addressed to an address on the white list, the server and the remote messaging server are configured to delete all quarantined messages addressed to an address on the black list and the server and the remote messaging server are configured to send a challenge message to the sender of messages addressed to an address that is neither on the white list or the black list.

In yet another further embodiment again, the server and the remote messaging server are configured to add the address of the sender of the quarantined message to the white list upon receipt of a response to the challenge message from the sender of the quarantined message.

In still yet another further embodiment, the server obtains copies of quarantined messages from the remote messaging server.

In still yet another further embodiment again, the server is configured to connect to a remote messaging server that buffers incoming messages addressed to a predetermined address in a quarantine folder.

In a further additional embodiment, the server is configured to instruct the remote messaging server to delete messages.

In another additional embodiment, the server is configured to instruct the remote messaging server to move messages into the inbox of the address of the intended recipient of the message.

In a still further additional embodiment, the server stores a white list of allowed addresses, the server stores a black list of prohibited addresses, the server is configured to connect to a plurality of remote messaging servers, the plurality of remote messaging servers store quarantined messages; and the server and the plurality of remote messaging servers are configured to apply a challenge response process to the quarantined messages using the white list and the black list stored on the server.

In still another additional embodiment, the server and the plurality of remote messaging servers are configured to release all quarantined messages addressed to an address on the white list, the server and the plurality of remote messaging servers are configured to delete all quarantined messages addressed to an address on the black list, and the server and the plurality of remote messaging servers are configured to send a challenge message to the sender of a message addressed to an address that is neither on the white list or the black list.

In a yet further additional embodiment, the server is configured to add the address of the sender of the quarantined message to the white list upon receipt by one of the plurality of remote messaging servers of a response to the challenge message from the sender of the quarantined message.

### BRIEF DESCRIPTION OF THE DRAWINGS

FIG. 1 is a schematic diagram of a network including mail processing units in accordance with an embodiment of the invention.

FIG. 2 is a schematic circuit diagram of a mail processing unit in accordance with an embodiment of the invention.

FIG. 3 is a flow chart showing a process for processing incoming mail messages in accordance with an embodiment of the invention.

FIG. 4 is a flow chart showing a process for extracting information from SMTP messages in accordance with an embodiment of the invention.

FIG. 5 is a flow chart showing a process for extracting information from SMTP messages and storing the information in an XML format in accordance with an embodiment of the invention.

FIGS. 6a and 6b are flow charts showing processes for storing received messages in accordance with an embodiment of the invention.

FIGS. 7a and 7b are flow charts showing processes for storing attachments to received messages in accordance with embodiments of the invention.

FIG. 8 is a flow chart showing a process for handling received messages including attachments in accordance with another embodiment of the invention.

FIG. 9 is a flow chart showing a process for sending messages in accordance with an embodiment of the invention.

FIG. 10 is a flow chart showing a process for sending messages in response to a user instruction in accordance with an embodiment of the invention.

FIG. 11 is a flow chart showing a process for rerouting messages in accordance with an embodiment of the invention.

FIG. 12 is a schematic diagram of a mail processing system in accordance with an embodiment of the invention.

### DETAILED DESCRIPTION OF THE INVENTION

Turning now to the drawings, embodiments of mail systems are shown. Many embodiments include mail processing units that receive messages, process messages and store messages. In a number of embodiments, the processing performed by the mail processing units involves filtering the messages using a challenge response based mail processing technique. In several embodiments, the mail processing units store a single copy of each message and each attachment to a message and forward to the message recipient links to the stored copies of the message and attachments. In a selection of embodiments, received messages are inspected and information is extracted from the message. In several embodiments, extracted information is stored using XML fields. In addition to processing and storing messages, mail processing units in accordance with many embodiments of the invention can provide additional functions with respect to sent messages such as the recall, rerouting or user authorized sending of messages.

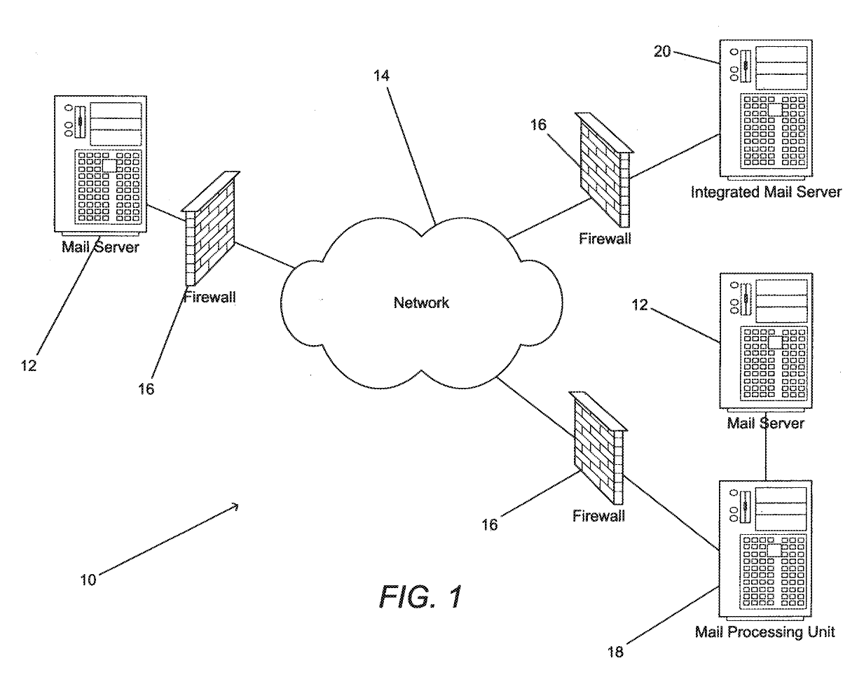

An electronic message system in accordance with an embodiment of the invention is shown in FIG. 1. The electronic message system 10 includes a number of mail servers 12 connected via a network 14. In the illustrated embodiment, each of the mail servers is protected by a firewall 16 that is interposed between the mail server 12 and the network 14. Several of the mail servers 12 are connected to the firewall 16 via a mail processing unit 18. In a number of instances, the functions of a mail server and a mail processing unit are performed by a single integrated mail server 20. Although the email servers are shown as being connected to the network via a firewall. In other embodiments, the mail servers can be connected to a network without use of a firewall.

In the illustrated embodiment, conventional mail servers, firewalls and networking technologies are illustrated. As can be readily appreciated, numerous implementations of mail servers, firewalls and networks can be connected together to exchange electronic messages.

Mail processing units in accordance with several embodiments of the invention handle messages received from the network prior to the messages reaching the mail server. In many embodiments, a mail processing unit admits messages using a challenge response process. While the mail processing unit may admit a message, the mail processing unit can often block or restrict access to undesirable attachments. In several embodiments, mail processing units attempt to extract information from received messages enabling the storage of the received messages. In a number of embodiments, the messages are stored as a database. In many embodiments, the information is stored in fields to facilitate location of messages and information within the database. In addition to handling messages received via the network, mail processing units in accordance with embodiments of the invention process messages forwarded by a mail server for transmission via the network. In many embodiments, the message is buffered. In several embodiments, the buffering of the message enables recall of the message, rerouting of the message and/or delay of the message pending a predetermined time or event such as user authorization to send the message.

Mail processing units in accordance with the present invention can be implemented using server hardware configured using appropriate software. In many embodiments, a single server that is appropriately configured using software can implement a mail processing unit and a mail server. Mail processing units in accordance with embodiments of the invention are discussed further below.

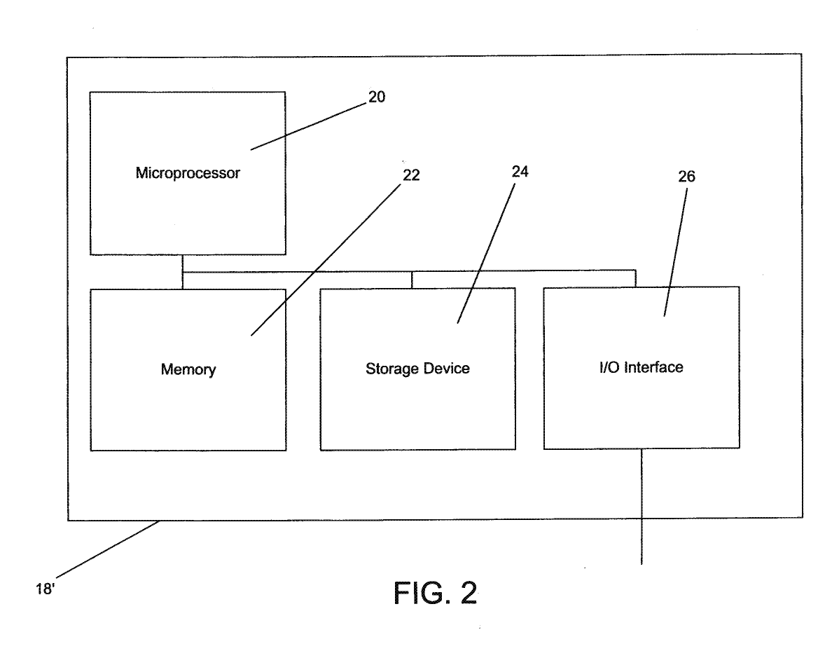

A mail processing unit in accordance with an embodiment of the invention is shown in FIG. 2. The mail processing unit 18′ includes a microprocessor 20 connected to memory 22, a storage device 24 and an I/O interface 26. In many embodiments the memory includes RAM and ROM. In several embodiments, the storage device includes a hard disk drive, CD/DVD-ROM drive and/or floppy disk drive. In a number of embodiments, the I/O interface includes network interfaces such as Ethernet connections. As can be readily appreciated any computer capable of being configured to perform functions including those described herein can be suitable for the implementation of a system in accordance with the invention.

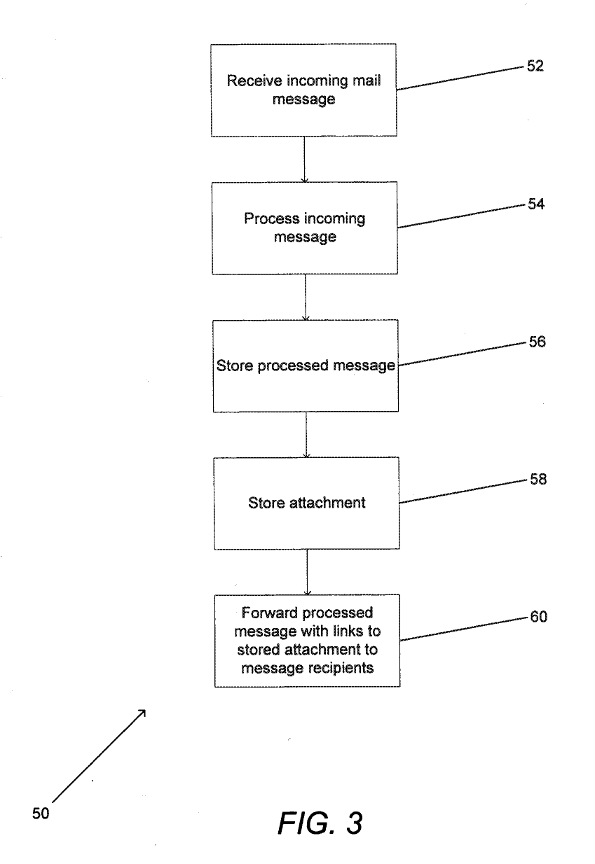

As discussed above, the fact that mail processing units in accordance with many embodiments of the present invention are interposed between the network and the mail server enables the mail processing unit to process mail prior to receipt by the mail server. A process for handling messages received via a network in accordance with one embodiment of the invention is shown in FIG. 3. The process 50 includes receiving (52) an incoming mail message, processing (54) the incoming message and storing (56) the processed message. In addition to storing the processed message, attachments to the message are stored (58) and the processed message is then forwarded (60) to the message's recipients with links to the stored attachments.

As discussed above, many mail processing units apply SPAM filtering as part of the processing of incoming messages. The SPAM filtering can involve using a filtering algorithm such as a Bayesian filter or using a challenge response process. In other embodiments, other SPAM filtering and/or other processes can be used to selectively admit messages.

In numerous embodiments, message processing includes reformatting the received message. Typically, messages are received via a network such as the internet and are formatted in accordance with a predetermined format. In many embodiments, the messages are formatted in accordance with Simple Mail Transfer Protocol (SMTP). The received messages contain information that is loosely structured. For example, the message can include recipients, a body and binary attachments. In a number of embodiments, received messages are processed to extract discrete pieces of information from the message. For example, the sender, the recipient, the body text and other discrete pieces of information associated with the message can be extracted and stored in fields. The fields can then be used to retrieve stored information concerning the messages and identify relationships between various messages.

In addition to processing and storing messages, mail processing units in accordance with many embodiments of the invention also process and store attachments to messages. Storing the message attachments and forwarding the message to recipients with a link to the stored attachments enables the quarantining of message attachments. In addition, the storage requirements of mail servers can be reduced. In many instances, messages are directed to multiple recipients on a mail server. Ordinarily, the attachment would be stored multiple times for each recipient. Storing a single instance of the attachment and forwarding a link can reduce the storage required by a mail server.

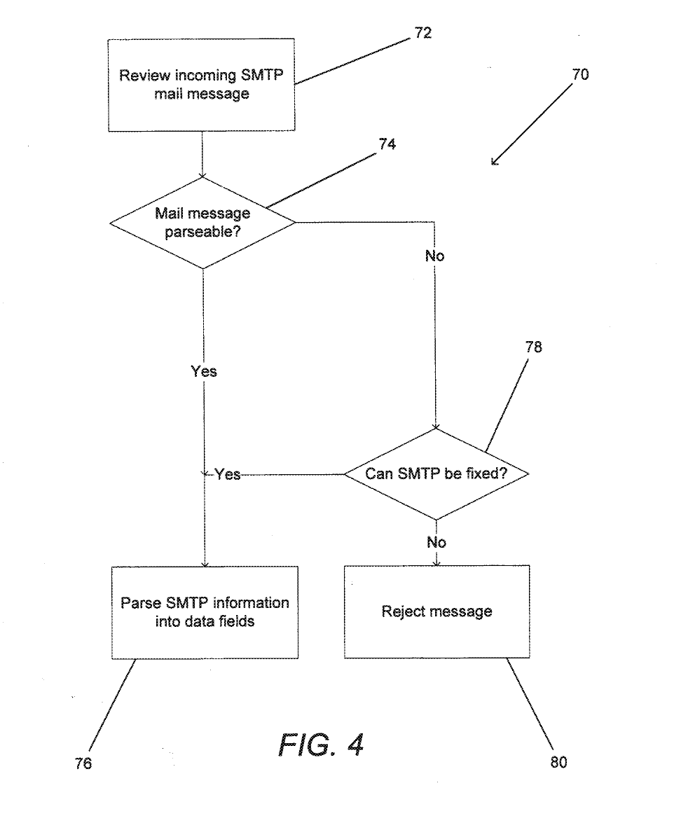

A process for extracting information from an SMTP message in accordance with an embodiment of the invention is shown in FIG. 4. The process 70 includes reviewing (72) the incoming SMTP message. A determination (74) is made as to whether the mail message is formatted correctly and that information can be parsed from the mail message. If the message can be parsed, then information is extracted from the SMTP and formatted for storage in a database. If the SMTP is corrupted, then a determination (78) is made as to whether the SMTP can be fixed. In the event that the SMTP can be fixed, then the message is parsed (76). Otherwise, the message is rejected (80).

As discussed above, information from messages can be extracted and stored in a database. Storage of the message information in a database enables searches to be performed within the database and relationships to be established between messages. In many embodiments, the messages are stored using Extensible Markup Language (XML) as specified by the World Wide Web Consortium. In other embodiments, other storage formats can be used.

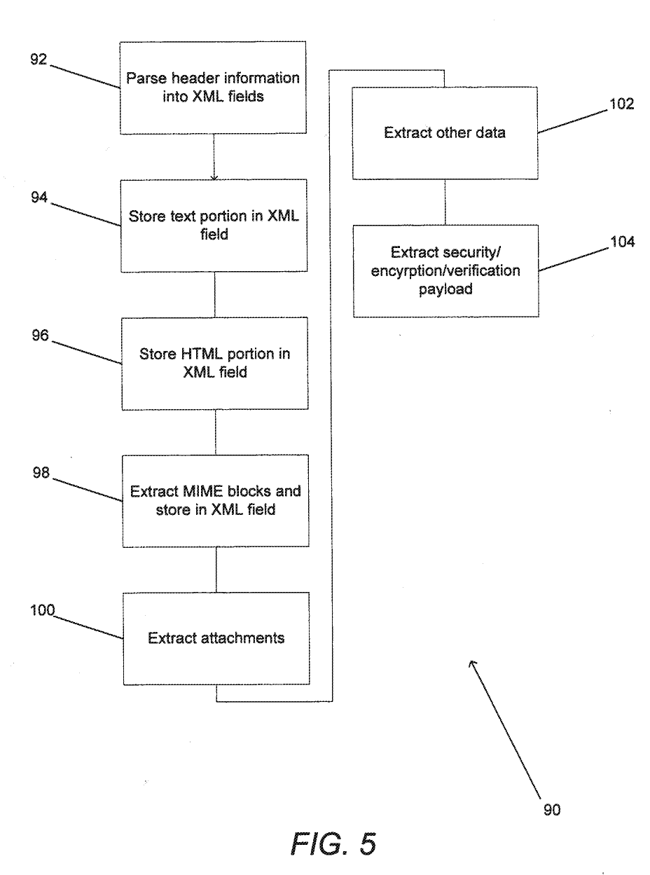

An embodiment of a process for extracting information from SMTP messages and storing the information in an XML format in accordance with an embodiment of the invention is shown in FIG. 5. The process 90 includes parsing (92) the header information into one or more XML fields. The text of the message is then stored (94) as one or more XML fields. Any Hypertext Markup Language (HTML) portions of the message are stored (96) as one or more XML fields. Any MIME blocks are stored (98) as one or more XML fields. Any attachments are then extracted (100), other types of data (102) are extracted and secure payloads are extracted (104).

Embodiments of processes similar to that shown in FIG. 5 involve breaking a received message into its constituent parts and storing the parts in an XML format. Other embodiments store the information in standard data formats or predetermined proprietary data formats.

As discussed above, several embodiments of the invention store single instances of messages and attachments. Single instance storage can prevent the storage of duplicate copies of messages and attachments. In addition, the storage process can be used as an opportunity to review messages and attachments. In many embodiments, the message and/or attachments are only stored if the messages comply with a predetermined policy. In several embodiments, a policy also specifies types of messages and attachments to store with restricted access. In a number of embodiments, stored messages and attachments are accessible after permission is granted by an entity possessing appropriate rights, such as a network administrator.

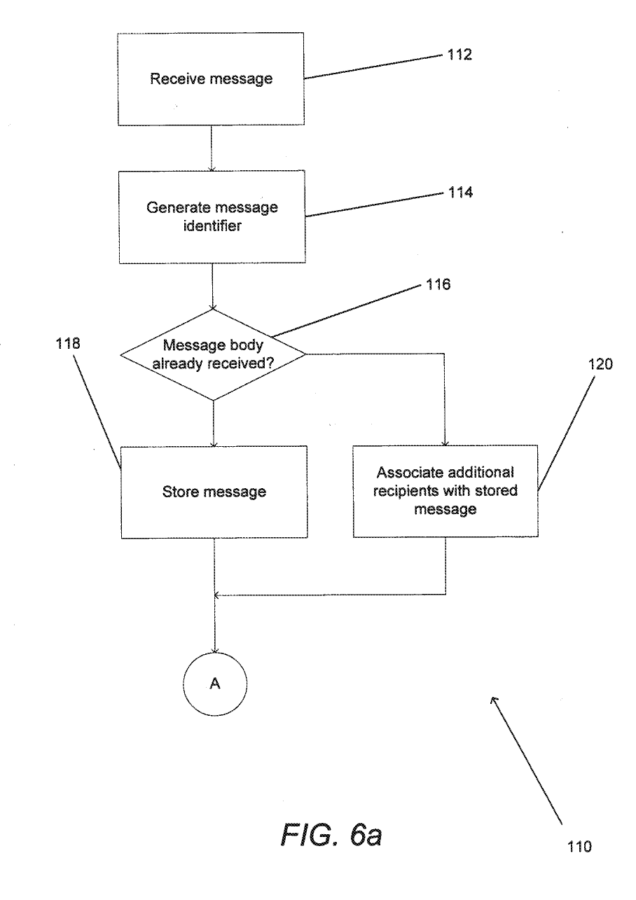

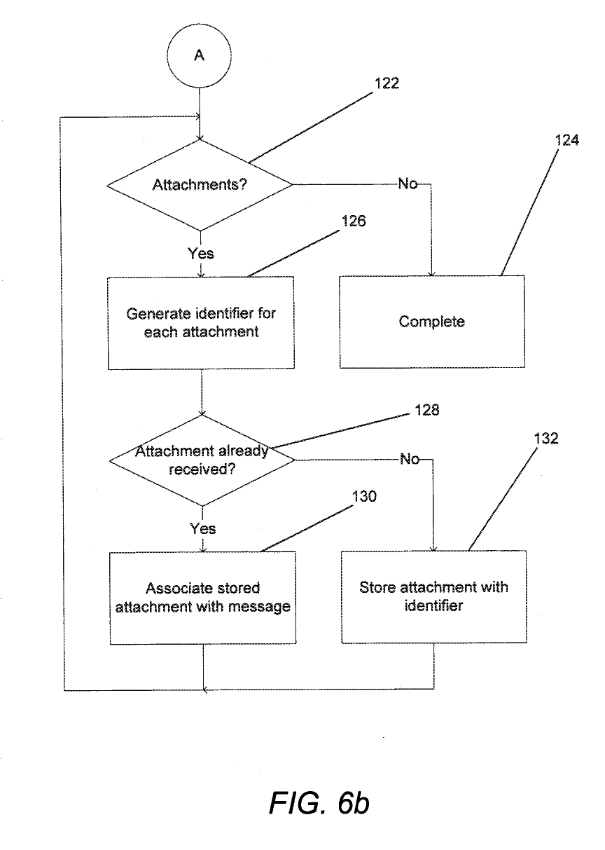

A process for storing received messages and message attachments in accordance with an embodiment of the invention is shown in FIGS. 6a and 6b. The process 110 includes receiving (112) a message and generating (114) a message identifier. The message identifier can be used to determine (116) whether the message body has already been received. If the message body has not been previously received, the message can be stored (118). In the event that the message body has been previously received by another recipient, then the new recipient is associated (120) with the stored message. Once the message body has been handled, a determination (122) is made as to whether there are any attachments to the message. In the event that there are no attachments, then the process is completed (124). In instances where a message includes attachments, an identifier is generated (126) for each attachment and a determination (128) is made as to whether the attachment has been received previously. If the attachment has been received previously, then the stored attachment is associated (130) with the new message. In instances where the attachment has not previously been received, the attachment is stored (132) and a relationship created between the stored attachment and the stored copy of the message with which the attachment is associated.

In many embodiments, a message identifier is generated by performing a hash function. The hash function can be performed on the entire message or can involve generating multiple hash values for different parts of the message. Examples of appropriate hash functions include the SHA1 function. In many embodiments, separate hash values are generated for the entire message, the headers and the body of the message. In other embodiments, other techniques for uniquely identifying messages are utilized. In several embodiments, identifiers are used to identify attachments that were previously received as attachments to messages differing from the currently received message. In this way, a document that is forwarded with different message bodies can be stored a single time and the message bodies stored separately and associated with a single copy of the forwarded document.

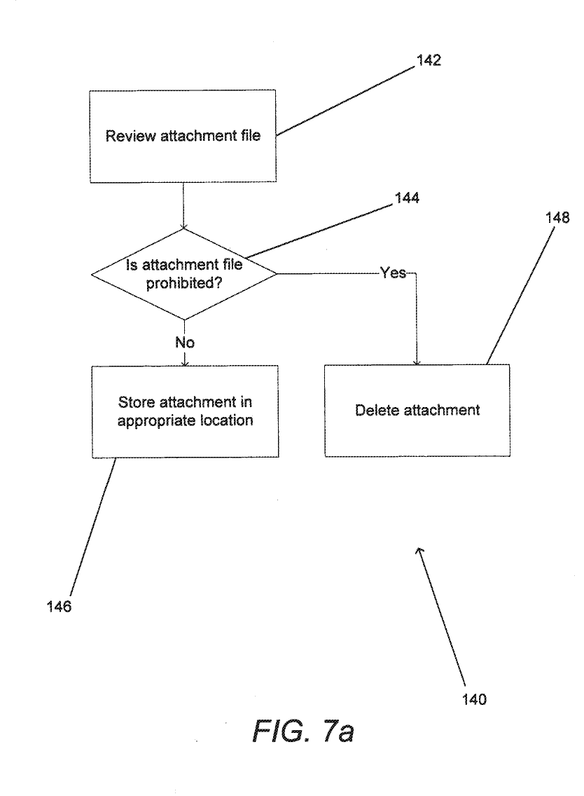

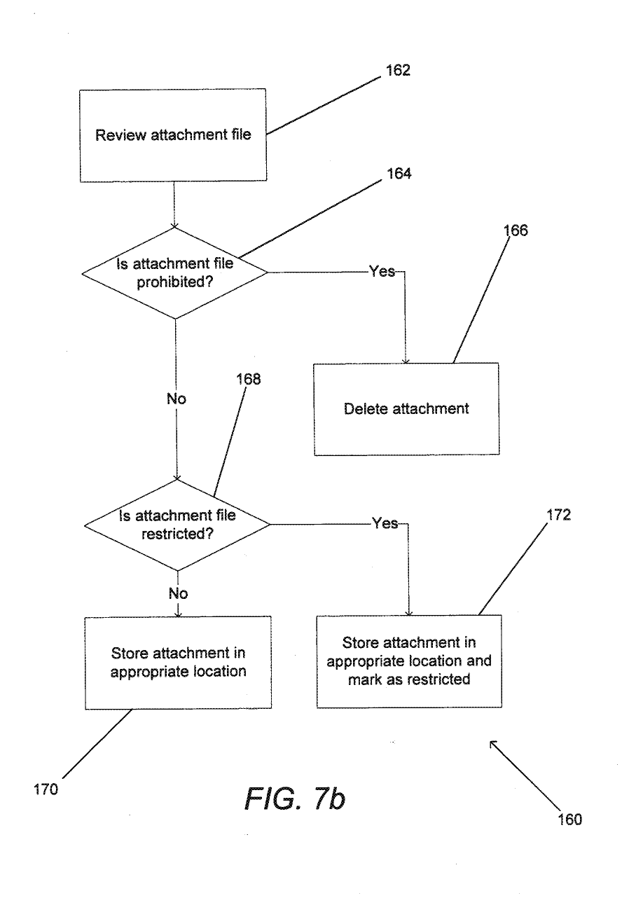

Assuming that an attachment has not been received before, mail processing units in accordance with several embodiments of the invention can refuse to store a message attachment on the basis that the attachment possesses prohibited characteristics. A process for selectively storing attachments in accordance with an embodiment of the invention is shown in FIG. 7a. The process 140 includes reviewing (142) the attachment to determine (144) if the attachment possesses characteristics that are prohibited. When the attachment possesses characteristics that are prohibited. The attachment is deleted (148). Otherwise, the attachment is stored (146) in an appropriate location.

In many embodiments, filters are used to determine whether attachments possess prohibited characteristics. The filters can identify prohibited attachments by general characteristics, such as whether the attachments are executable or include objectionable content. In addition, the filters can identify specific attachments such as known viruses. In other embodiments, other characteristics can be the basis of prohibiting the storage of an attachment. The other characteristics could include the file name or file extension of the attachment (e.g. the file is named file.doc, or archive.zip) and/or the mime content type as specified in the message itself.

In addition to prohibiting storage of an attachment, several embodiments of the invention enable the storage of certain types of attachments and restrict access to the attachments once stored. A process for selectively storing and restricting access to an attachment in accordance with an embodiment of the invention is shown in FIG. 7b. The process 160 includes reviewing (162) the attached file to determine (164) whether the attached file possesses characteristics that are prohibited. If the attachment possesses characteristics that are prohibited, the attachment is deleted (166). If the attachment is not prohibited, then a determination (168) is made concerning whether the attachment possesses characteristics that indicate access to the attachment should be restricted. If the attachment does not possess characteristics indicating that access should be restricted, the attachment is stored (170) and is freely accessible. When the attachment possesses characteristics that indicate that access to the attachment should be restricted, the attachment is stored (172) in a way that restricts access to the attachment. In many embodiments, access is restricted using additional data to indicate that access to the attachment is restricted.

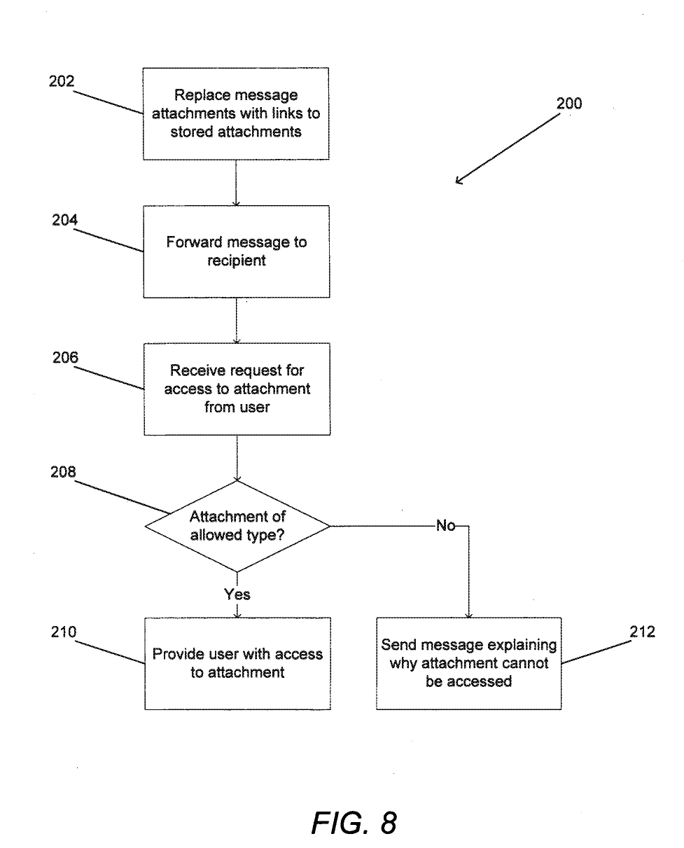

As discussed above, many embodiments of the invention store attachments and forward messages with links to the stored attachments. An embodiment of a process for handling the forwarding of messages and the access of attachments, which can be restricted, is shown in FIG. 8. The process 200 includes replacing (202) attachments to messages with links to the stored attachments. The message is then forwarded (204) to the recipient. The recipient of the message can then request (206) access to the attachment. In response to the request, a determination (208) is made as to whether access to the attachment is restricted. The recipient is provided access (210) to unrestricted attachments. When access to an attachment is restricted, the recipient often receives (212) a message explaining that access is restricted and/or the reason that access to the attachment is denied.

Many of the processes outlined above are directed toward the receipt and handling of messages by mail processing units. Mail processing units in accordance with several embodiments of the invention are capable of forwarding messages over a network. In forwarding the messages, the mail processing units can buffer the messages for predetermined periods of time before release. The buffering period can be used to ensure that mail is not released until the mail server of the recipient confirms responsibility for delivery of the message. In addition, the buffering period can be used to enable recall of a message or rerouting of an incorrectly addressed message. In many embodiments, the mail processing unit is configured to buffer messages for a predetermined period of time. In several embodiments, users can authorize the release of messages prior to the expiration of the predetermined buffer period. In a number of embodiments, the user is able to establish the predetermined buffering period. In addition to buffering the message, embodiments that include a database can store copies of sent messages and attachments within the database.

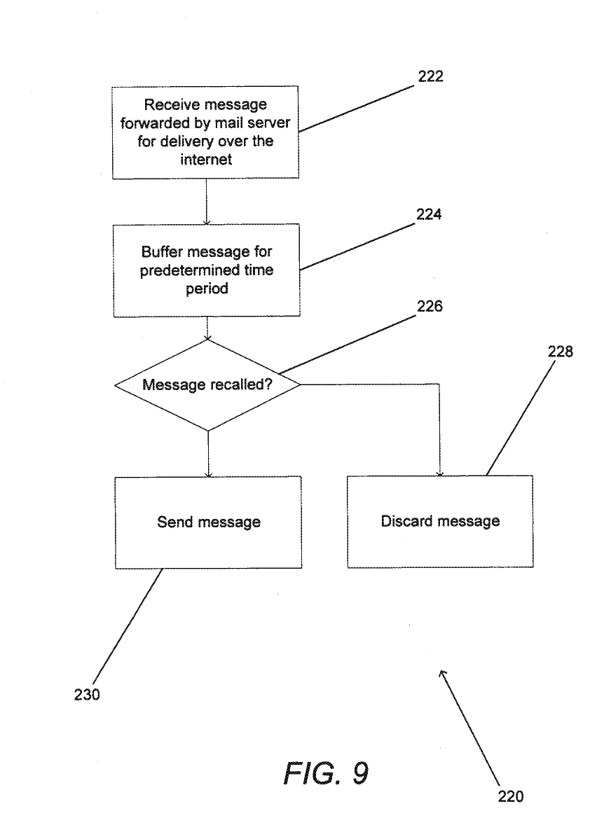

A process for forwarding a message over a network in accordance with an embodiment of the invention is shown in FIG. 9. The process 220 includes receiving (222) a message forwarded by the sender's mail server for delivery via a network. The message is buffered (224) for a predetermined period of time. During the period in which the message is buffered, a determination (226) is made as to whether the user has recalled the message. If the user recalls the message, the message is discarded (228). When the buffer period expires without the message being recalled, the message is sent (230) to the intended recipient(s) via the network.

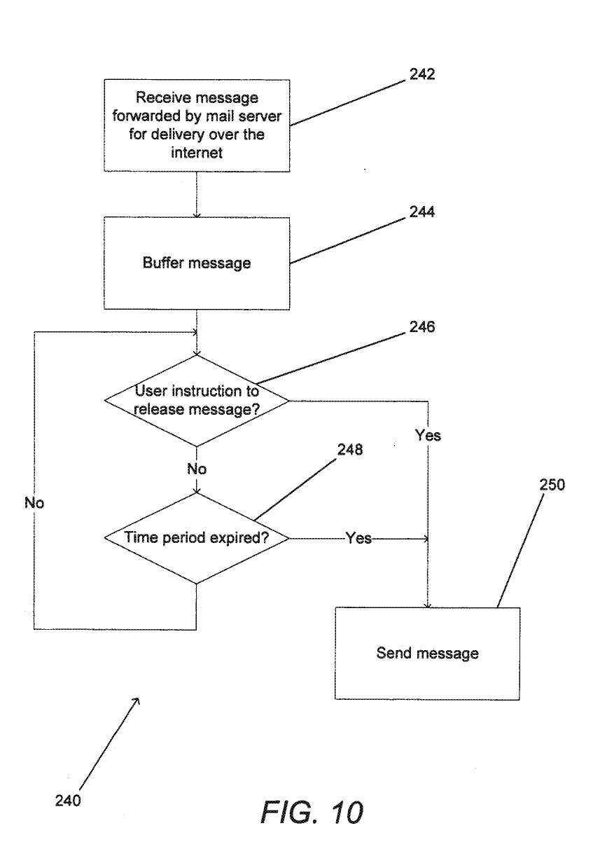

An embodiment of a process for buffering a message for a predetermined period of time before releasing the message unless contrary instructions are received by a user in accordance with an embodiment of the invention is shown in FIG. 10. The process 240 includes receiving (242) a message forwarded by a mail server for delivery via a network. The message is buffered (244) for a predetermined period of time. During the buffering period, a determination (246) is made as to whether the user has released the message and a determination (248) is made as to whether the time period has expired. In either event, the message is sent (250).

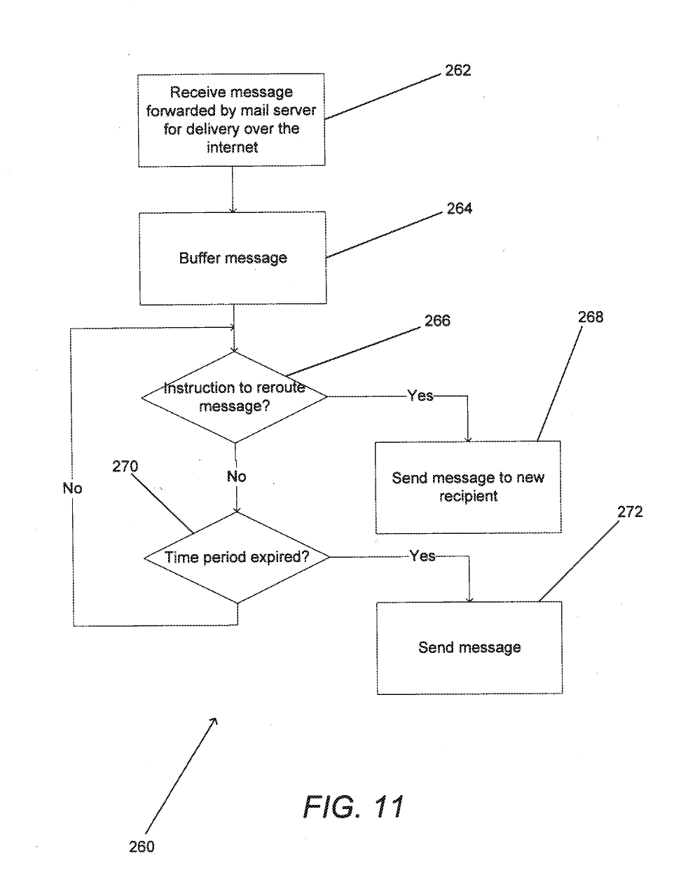

A process for forwarding messages in a way that allows for subsequent rerouting of the message in accordance with an embodiment of the invention is shown in FIG. 11. The process 260 includes receiving (262) a message forwarded by a mail server for delivery via a network. The received message is buffered (264) for a predetermined period of time. During that time, repeated determinations (266) are made as to whether an instruction to reroute the message has been received. In the event that such an instruction is received, the message is sent (268) to the new recipient(s). Otherwise, a determination (270) is made concerning whether the time period has ended. When the predetermined buffering period ends, the message is sent (272).

As can be readily appreciated combinations of processes for buffering and processing messages prior to transmission can be utilized by mail processing units in accordance with embodiments of the invention. In addition, any of a variety of processing steps can be performed with respect to the buffered messages including storage of the message in a database.

In systems in accordance with embodiments of the invention where messages are communicated between a sender and a receiver mail processing unit, encryption can be used to encrypt all or a portion of the message and its attachments during transmission over the network. The sender's mail processing unit can receive a message from a mail server and buffer the message until communication is received from the receiver's mail processing unit confirming responsibility for delivery of the message. If the communication indicates the capability of decoding encrypted messages, then the sender's mail processing unit can encrypt all or part of the message and transmit the message over the network. The encryption could use shared key encryption, public/private key encryption, scrambling, or any other secure means of transferring the message.

As discussed above, many embodiments of the invention apply a challenge response process to incoming mail. In a number of embodiments, a mail processing unit can remotely connect to a mail server that stores incoming messages in a quarantine folder. The mail processing unit can then inspect each message and perform processing functions such as those outlined above. In several embodiments, the mail processing unit applies a challenge response process to the quarantined messages. The mail processing unit can use the remote mail server to perform the challenge and receive the response. In other embodiments, the mail processing unit itself performs the challenge response. In many embodiments, a single mail processing unit can be used to apply a challenge response process to multiple remote email accounts. In this way, a single white list and black list is maintained. In addition, a single response is sufficient for a message sender to be added to the white list for each of a recipient's participating mail accounts.

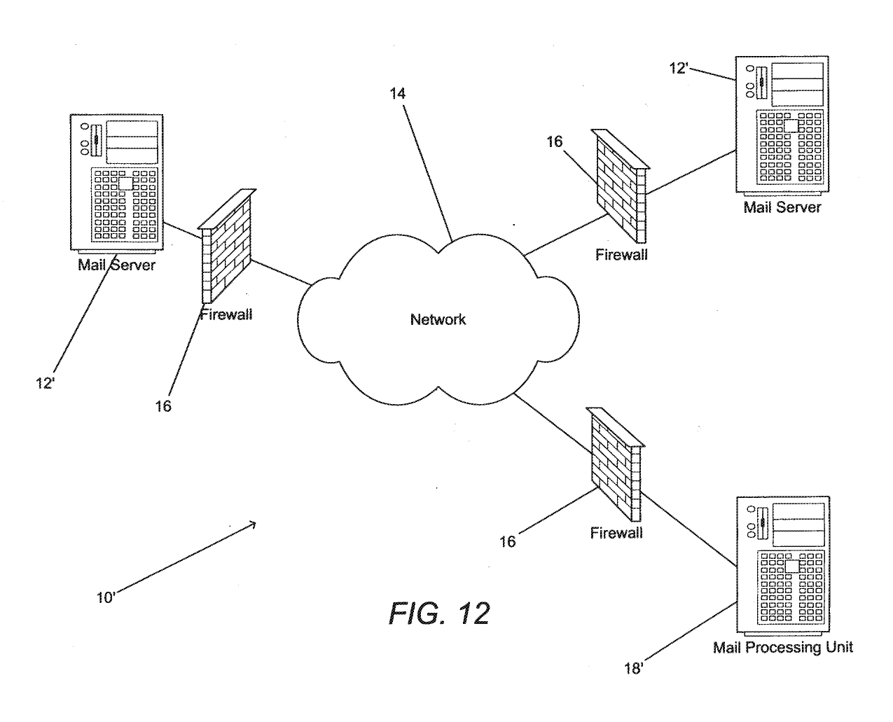

A system in accordance with an embodiment of the present invention including a mail processing unit capable of processing mail at a remote mail server is shown in FIG. 12. The system 10′ includes a mail server 12′ connected to a network 14 via a firewall. A mail processing unit 18′ is also connected to the network 14 via a firewall 16. Although connections via firewalls are shown, in other embodiments the network connections need not involve a firewall.

As discussed above, the mail processing unit can remotely connect with the mail server and via a protocol such as POP3 can obtain copies of mail from the mail server. In other embodiments, other techniques for obtain information from a mail server can be used including Internet Message Access Protocol (IMAP), web services and/or direct Application Programming Interfaces (APIs). In many embodiments, the mail server buffers all incoming messages in a quarantine folder. The mail processing unit can request all messages in the quarantine folder. The mail processing unit can then process the messages from the quarantine folder and provide the mail server with instructions concerning the handling of each message. In many embodiments, a challenge response process is applied to quarantined messages. In other embodiments, other SPAM filtering techniques can be implied including techniques that accommodate white and/or black lists. The mail processing unit instructs the mail server to delete all messages from non-responsive senders and can instruct the mail processing unit to move valid messages into the recipient's inbox. In a number of embodiments, the mail processing unit includes a database and valid mail messages are also stored in the database in a manner similar to that outlined above.

While the above description contains many specific embodiments of the invention, these should not be construed as limitations on the scope of the invention, but rather as an example of one embodiment thereof. For example, many different network architectures can be used. In addition, one, many or a combination of the processes outlined above can be implemented on a single mail processing unit in accordance with embodiments of the invention. Furthermore, although the above discussion frequently references handling of email messages, embodiments of the invention can be used to apply challenge response filters and the other processes described above to other types of messages including text messages such as Short Message Service (SMS) text messages. In many embodiments, a white list and black list is maintained for a variety of messaging services and a response to a challenge using a first messaging service can result in the sender of the response being added to the white list of a number of services. Accordingly, the scope of the invention should be determined not by the embodiments illustrated, but by the appended claims and their equivalents.

What is claimed is:

1. A system for exchanging electronic messages between users, comprising:
a message processing system connected to a network;
wherein the message processing system comprises:
a mail processing unit connected to the network; and
a mail server connected to the mail processing unit;
wherein the mail processing unit is configured to apply a challenge response process to messages addressed to the at least one user; and
wherein the mail server is configured to transfer electronic messages from one user to another user.

2. The electronic message system of claim 1, wherein the mail processing unit is connected to the network via a firewall.

3. The electronic message system of claim 1, wherein the mail processing unit and mail server are implemented on a single server using software.

4. A mail processing unit, comprising:
a microprocessor connected to memory;
a storage device; and
an I/O interface;
wherein the I/O interface includes a network connection configured to communicate with a network;
wherein the I/O interface includes a mail server connection configured to communicate with a mail server;
wherein the microprocessor is configured to receive electronic message from the network connection;
wherein the microprocessor is configured to apply a challenge response process to the received electronic messages; and
wherein the microprocessor is configured to forward filtered electronic messages via the mail server connection.

5. The mail processing unit of claim 4, wherein:
the memory includes a black list of senders and a white list of senders;
the microprocessor is configured to forward all received electronic messages via the mail server connection that include a sender address that is on the white list of senders; and
the microprocessor is configured to delete all received electronic messages that include a sender address that is on the black list of senders.

6. The mail processing unit of claim 5, wherein:
the memory includes a challenge list of addresses to which challenge messages have been sent;
the microprocessor is configured to store on the storage device all received electronic messages that include a sender address that is not on the white list, or the black list;
the microprocessor is configured to send a challenge message in response to all received electronic messages that include a sender address that is not on the white list, the black list nor the challenge list;
the microprocessor is configured to add the address of the sender to which a challenge message has been sent to the challenge list.

7. The mail processing unit of claim 6, wherein:
the microprocessor is configured to remove from the challenge list the address of a sender of a response to a challenge message and to place the address on the white list;
the microprocessor is configured to locate messages stored on the storage device with a sender address that matches the sender address of the response to the challenge message; and
the microprocessor is configured to forward the located messages via the mail server connection.

8. The mail processing unit of claim 4, wherein:
the microprocessor is configured to parse filtered electronic messages that are formatted in accordance with the Simple Mail Transfer Protocol to extract information into fields;
the microprocessor is configured to generate new electronic messages using the information extracted into the fields;
the microprocessor is configured to store the new electronic messages on the storage device; and
the microprocessor is configured to forward the new electronic messages via the mail server connection.

9. The mail processing unit of claim 8, wherein the electronic messages are stored on the storage device within a database.

10. The mail processing unit of claim 9, wherein the microprocessor is configured to retrieve electronic messages stored on the storage device by searching fields of information within the electronic messages.

11. The mail processing unit of claim 4, wherein:
the microprocessor is configured to store attachments to the electronic messages on the storage device; and
the microprocessor is configured to replace the attachments to the electronic messages with links to the stored attachments.

12. The mail processing unit of claim 11, wherein the microprocessor is configured to screen attachments to detect attachments with characteristics that indicate that access to the attachment should be restricted.

13. The mail processing unit of claim 4, wherein the microprocessor is configured to buffer a message received from the mail server connection.

14. The mail processing unit of claim 13, wherein:
the buffered message is addressed to a destination mail server; and
the microprocessor is configured to forward the buffered message to the destination mail server after a predetermined time period.

15. The mail processing unit of claim 13, wherein:
the buffered message is addressed to a destination mail server; and
the microprocessor is configured to forward the buffered message upon receipt of confirmation that the destination mail server accepts responsibility for the delivery of the message.

16. The mail processing unit of claim 13, wherein the microprocessor is configured to release the buffered message upon receipt of authorization from the sender of the message.

17. The mail processing unit of claim 13, wherein:
the buffered message is addressed to a first destination server; and
the microprocessor is configured to address the buffered message to a second destination server in response to an instruction from the sender of the message.

18. The mail processing unit of claim 13, wherein:
the buffered message is addressed to a destination mail server;
the microprocessor is configured to determine that the destination mail server is connected to a second mail processing unit; and
the microprocessor is configured to encrypt at least a portion of the buffered message and forward the buffered message to the second mail processing unit.

19. A message processing system configured to apply a challenge response filter to messages stored at a remote message server, comprising:
a server configured to connect to a remote message server via a network; and
wherein the server is configured to control the remote messaging server to apply a challenge response process to messages quarantined on the remote messaging server.

20. The message processing system of claim 19, wherein:
the server maintains a white list of allowed addresses;
the server maintains a black list of forbidden addresses;
the server and the remote messaging server are configured to release all quarantined messages addressed to an address on the white list;
the server and the remote messaging server are configured to delete all quarantined messages addressed to an address on the black list; and
the server and the remote messaging server are configured to send a challenge message to the sender of messages addressed to an address that is neither on the white list or the black list.

21. The message processing system of claim 20, wherein the server and the remote messaging server are configured to add the address of the sender of the quarantined message to the white list upon receipt of a response to the challenge message from the sender of the quarantined message.

22. The message processing system of claim 19, wherein the server obtains copies of quarantined messages from the remote messaging server.

23. The message processing system of claim 19, wherein the server is configured to connect to a remote messaging server that buffers incoming messages addressed to a predetermined address in a quarantine folder.

24. The message processing system of claim 23, wherein the server is configured to instruct the remote messaging server to delete messages.

25. The message processing system of claim 23, wherein the server is configured to instruct the remote messaging server to move messages into the inbox of the address of the intended recipient of the message.

26. The message processing system of claim 19, wherein:
the server stores a white list of allowed addresses;
the server stores a black list of prohibited addresses;
the server is configured to connect to a plurality of remote messaging servers;
the plurality of remote messaging servers store quarantined messages; and
the server and the plurality of remote messaging servers are configured to apply a challenge response process to the quarantined messages using the white list and the black list stored on the server.

27. The message processing system of claim 26, wherein:
the server and the plurality of remote messaging servers are configured to release all quarantined messages addressed to an address on the white list;
the server and the plurality of remote messaging servers are configured to delete all quarantined messages addressed to an address on the black list;
the server and the plurality of remote messaging servers are configured to send a challenge message to the sender of a message addressed to an address that is neither on the white list or the black list.

28. The message processing system of claim 27, wherein the server is configured to add the address of the sender of the quarantined message to the white list upon receipt by one of the plurality of remote messaging servers of a response to the challenge message from the sender of the quarantined message.
